(19) United States
(12) Patent Application Publication
(10) Pub. No.: US 2026/0166636 A1
(43) Pub. Date: Jun. 18, 2026

(54) Outfeed Support Assembly having a Movable Outfeed Support Member

(71) Applicant: Robert Bosch GmbH, Stuttgart (DE)

(72) Inventors: Hannah Higgins, Batavia, IL (US); Andrew Frolov, Glenview, IL (US); Tomas Peleckas, Chicago, IL (US)

(21) Appl. No.: 18/978,473

(22) Filed: Dec. 12, 2024

(51) Int. Cl. B23D 47/02; B23D 45/06

(52) U.S. Cl. CPC B23D 47/02; B23D 45/06

(57) ABSTRACT

An outfeed support assembly includes a first outfeed support member having a first upper portion, the first outfeed support member defining a cutout portion. The outfeed support assembly also has a second outfeed support member that is movably connected to the first outfeed support member. The second outfeed support member has a first position in which the second outfeed support member is arranged in the cutout portion and a second upper portion of the second outfeed support member is substantially coplanar with the first upper portion, and a second position in which the second outfeed support member is at least partially outside the cutout portion.

### FIELD

This disclosure relates generally to table saws, and, more particularly, to outfeed support assemblies for table saws.

### BACKGROUND

Benchtop cutting tools, such as table saws, are valuable tools used for a variety of tasks, such as cross-cutting wood, and ripping large boards or panels into narrow strips. While there are a variety of table saw designs, most table saws include a base housing structure that supports a table top and a cutting assembly positioned below the table top. The table top has a substantially planar upper surface upon which workpieces may be supported.

The cutting assembly includes a circular saw blade that is mounted on an arbor with a portion of the blade extending upwardly through an opening defined in the table top. The cutting assembly also includes a motor with power train for rotating the arbor so that the cutting blade may be driven to perform cutting operations on workpieces supported on the table top. As the motor drives the cutting blade to rotate, a workpiece may be moved across the table top against the blade to allow the blade to cut the workpiece.

Most table saws include a workpiece support surface and a cutting blade that extends through an opening in the workpiece support surface. The workpiece support surface is a generally flat surface on which a user positions the workpiece for cutting. The cutting blade, typically a circular sawblade, is configured for rotation by an electric motor that is positioned below the support surface. An upper portion of the blade extends above the support surface through the opening in the support surface and is configured to contact the workpiece. A riving knife is positioned behind the sawblade and moves through a kerf in the workpiece to prevent jamming of the workpiece during a cutting operation.

To offer added support when cutting workpieces on a portable or jobsite table saw, it is common for the table saw to include attachable left and rear outfeed supports. These supports usually include brackets that attach to the underside of the table top and a support plate connected to two elongated rods. The elongated rods are assembled into the brackets, which allows the outfeed support to be stored close to the table saw and extended out when material support is needed.

The workpiece support surface of some table saws is partially defined by a sliding table portion to the left of the sawblade. The sliding table portion is movable relative to the sawblade in the direction parallel to the saw blade and is used to support a workpiece and facilitate guiding of the workpiece during a cutting process. That is, the sliding table and the workpiece are moved past the sawblade to make a cut in the workpiece. However, in some positions the sliding table portion projects beyond the end of the table, and the sliding table portion may therefore interfere with the outfeed support or limit the size of the outfeed support. Therefore, an improved outfeed support that facilitates use of the sliding table portion is needed.

### SUMMARY

In some aspects, the techniques described herein relate to an outfeed support assembly for a table saw including: a first outfeed support member having a first upper portion, the first outfeed support member defining a cutout portion; and a second outfeed support member that is movably connected to the first outfeed support member, the second outfeed support member having a first position in which the second outfeed support member is arranged in the cutout portion and a second upper portion of the second outfeed support member is substantially coplanar with the first upper portion, and a second position in which the second outfeed support member is at least partially outside the cutout portion.

In other aspects, the techniques described herein relate to a table saw including: a table assembly having a table top and a sliding table portion; and an outfeed support assembly including: a first outfeed support member having a first upper portion, the first outfeed support member defining a cutout portion; and a second outfeed support member that is movably connected to the first outfeed support member, the second outfeed support member having a first position in which the second outfeed support member is arranged in the cutout portion and a second upper portion of the second outfeed support member is substantially coplanar with the first upper portion, and a second position in which the second outfeed support member is at least partially outside the cutout portion.

In some aspects, the techniques described herein relate to an outfeed support assembly for a table saw including: a first outfeed support plate having a first upper portion, the first outfeed support plate defining a cutout portion; and a second outfeed support plate that is movably connected to the first outfeed support plate, the second outfeed support plate having a first position in which the second outfeed support plate is arranged in the cutout portion and a second upper portion of the second outfeed support plate is substantially coplanar with the first upper portion, and a second position in which the second outfeed support plate is at least partially outside the cutout portion, wherein second outfeed support plate pivots relative to the first outfeed support plate between the first and second positions about a pivot axis that is substantially parallel to a plane defined by the first and second upper portions.

### BRIEF DESCRIPTION OF THE DRAWINGS

FIG. 1 is a front-left perspective view of a table saw having an outfeed support assembly with a movable second outfeed support member shown in a first position.

FIG. 2 is a front-left perspective view of the outfeed support assembly of FIG. 1.

FIG. 3 is a front elevational view of a portion of the outfeed support assembly of FIG. 1 depicting the second outfeed support member in the first position.

FIG. 4 is a rear elevational view of a portion of the outfeed support assembly of FIG. 1 depicting the second outfeed support member in the first position.

FIG. 5 is a rear elevational view of a portion of the outfeed support assembly of FIG. 1 depicting the second outfeed support member in the second position.

FIG. 6 is a front-left perspective view of the table saw of FIG. 1 depicting the second outfeed support member of the outfeed support assembly in the second position.

FIG. 7 is a front-left perspective view of the table saw of FIG. 1 depicting the second outfeed support member of the outfeed support assembly in the second position and the sliding table portion extending through the cutout of the first outfeed support member.

### DETAILED DESCRIPTION

For the purposes of promoting an understanding of the principles of the embodiments described herein, reference is now made to the drawings and descriptions in the following written specification. No limitation to the scope of the subject matter is intended by the references. This disclosure also includes any alterations and modifications to the illustrated embodiments and includes further applications of the principles of the described embodiments as would normally occur to one skilled in the art to which this document pertains.

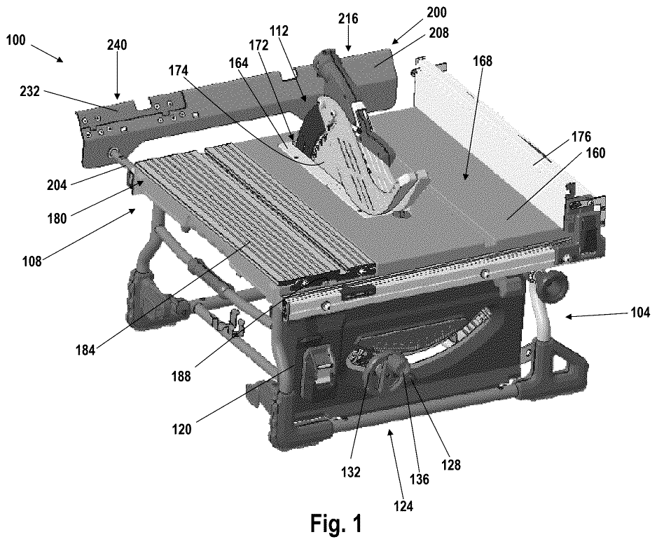

FIG. 1 depicts a table saw 100 according to one embodiment of the disclosure that is designed to cut through larger workpieces than a conventional table saw of the same blade size. The table saw 100 includes a base assembly 104, a table assembly 108, and a saw assembly 112. The base assembly 104 is configured to support the table assembly 108, which supports the saw assembly 112 via trunnions (not shown) attached to the table assembly 108. The base assembly 104 may include a frame structure or housing 120 enclosing the saw assembly 112, and one or more handles (not shown) that enable a user to easily transport the table saw 100.

In addition, the base assembly 104 includes an adjustment mechanism 124, which may include various actuators such as a bevel adjustment locking lever 128, a height adjustment wheel 132, and a height adjustment wheel handle 136. The adjustment mechanism 124 is configured such that turning the height adjustment wheel 132 causes the saw assembly 112 to move upwardly relative to the table top 160 between a recessed position, at which the saw blade 174 is entirely beneath the table assembly 108, and a maximum cutting height position. Moving the height adjustment wheel 132 laterally, with the bevel adjustment locking lever 128 disengaged, causes the saw assembly 112 to pivot relative to the table assembly 108 for a bevel cut.

The table assembly 108 includes a table top 160 and a throat plate 164, which jointly define a support surface 168 configured to support a workpiece during cutting. The throat plate 164 defines a generally rectangular throat opening 172 through which a saw blade 174 extends when positioned for a cutting operation. The table top 160 may also include a rip fence assembly 176 that is configured to provide support to the side of a workpiece during a rip cut.

Additionally, the table assembly 108 includes a sliding table portion 180 that forms a portion of the support surface 168 of the table assembly 108. The sliding table portion 180 is formed as a plate 184 arranged within a recess 188 of the table top 160 and configured such that an upper surface of the plate 184 is generally coplanar with the top surface of the table top 160. The sliding table portion 180 is guided in guide grooves of the table top 160 that extend generally parallel to a plane defined by the throat opening 172, i.e. the plane defined by the saw blade 174 when the saw blade 174 is installed on the table saw 100. The sliding table portion 180 is therefore movable relative to the table top 160 along a sliding axis that is generally parallel to the saw blade 174, or parallel to the direction of the cut into a workpiece. As a result, the sliding table portion 180 provides an extension of the support surface 168 of the table assembly 108 to facilitate guiding a large workpiece during a cutting process. In particular, the plate 184 of the sliding table portion 180 extends to the left edge of the table top 160, thereby providing a slidable support at the left end of the table top 160.

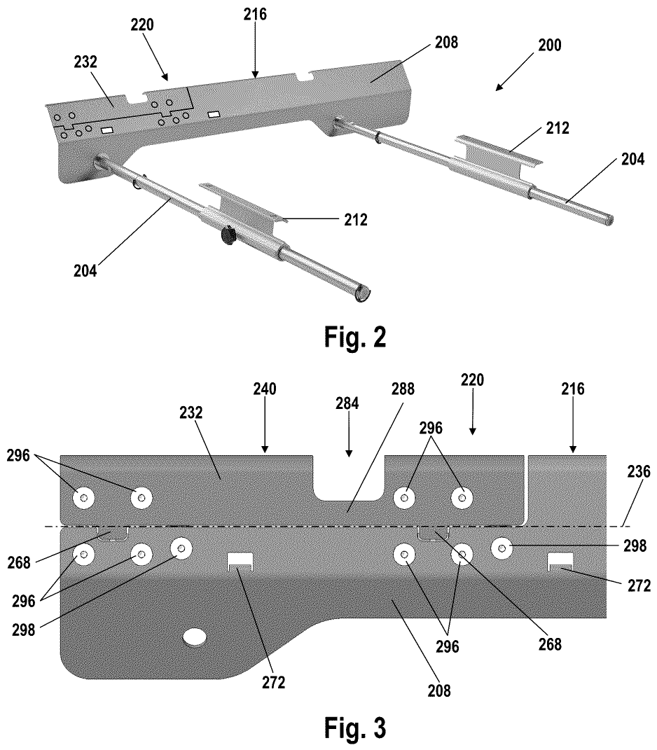

The table saw 100 also has an outfeed support assembly 200 configured to provide additional support for longer workpieces. As is best seen in FIG. 2, the outfeed support assembly 200 includes two extension rods 204 and a first outfeed support member 208. Each of the two extension rods 204 is slidably received in a respective bracket 212. Each of the brackets 212 is fixedly mounted to the underside of the table top 160.

In the illustrated embodiment, the first outfeed support member 208 is formed by a plate having a first portion that is substantially perpendicular to the plane defined by the saw blade 174 and a second portion that is bent out of the plane in a direction away from the table top 160 by an angle of between approximately 10° and approximately 40°, and in particular by an angle of between approximately 20° and approximately 30°.

The first outfeed support member 208 further includes an upper portion 216, which may be, for example, a surface or edge that extends across the width of the table saw 100 and defines a first plane that is substantially coplanar with the support surface 168 of the table top 160. In the illustrated embodiment, the upper portion 216 is formed as a further bend of the plate of the first outfeed support member 208 that defines the surface or edge. Because the outfeed support assembly 200 is movable away from the table top 160 as the two extension rods 204 slide in the respective bracket 212. In particular, the outfeed support assembly 200 may be movable relative to the table top 160 in the direction of the sliding axis of the sliding table portion 180. The upper portion 216 remains substantially coplanar with the table top 160 as the outfeed support assembly moves relative to the table top 160, thereby enabling the upper portion 216 of the first outfeed support member 208 to provide additional outfeed support to a workpiece at a position that is spaced apart from the table top 160.

In conventional table saws that include both a sliding table portion and an outfeed support assembly, the outfeed support would ordinarily interfere with movement of the sliding table beyond the outfeed end of the table saw. In the outfeed support assembly 200 according to the disclosure, however, the first outfeed support member 208 includes a cutout portion 220 that is generally aligned with the plate 184 of the sliding table portion 180, and that has a slightly larger cross-sectional area than the cross-sectional area of the plate 184.

The outfeed support assembly 200 further includes a second outfeed support member 232, configured in the illustrated embodiment as an auxiliary outfeed support plate, arranged, in a first position, also referred to as an upright position, in the cutout portion 220. The second outfeed support member 232 is movable relative to the first outfeed support member 208 between the first position, in which the second outfeed support member 232 is arranged in the cutout portion 220, and a second position in which the second outfeed support member 232 is at least partially outside the cutout portion 220 and, more specifically, is arranged outside at least the region of the cutout portion 220 through which the plate 184 of the sliding table portion 180 moves.

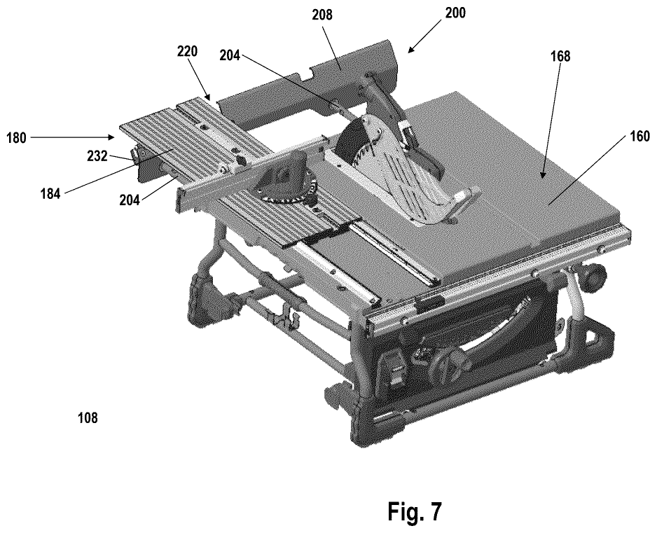

In particular, in the embodiment depicted in FIGS. 1-7, the second outfeed support member 232 is pivotable relative to the first outfeed support member 208 about an axis 236 that is parallel to or generally parallel to the top surface or edge of the upper portion 216 of the first outfeed support member 208. The second outfeed support member 232 has an upper portion 240 configured such that, when the second outfeed support member 232 is in the first position, the upper surface or edge of the upper portion 240 defines a second plane that is substantially coplanar with the first plane defined by the top surface or edge of the upper portion 216 of the first outfeed support member 208. As a result, in the first position, the second outfeed support member 232 provides additional outfeed support for the workpiece in the region of the cutout portion 220.

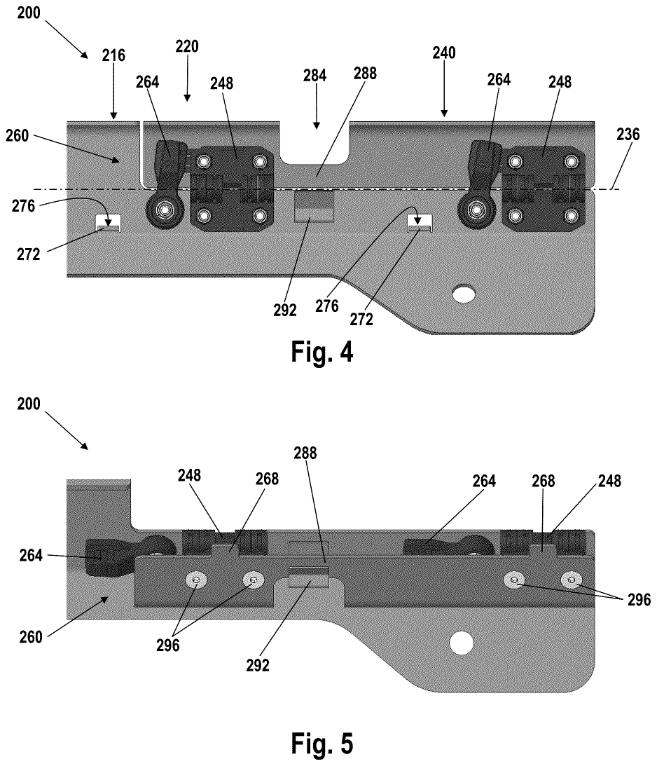

As noted above, the second outfeed support member 232 also has a second position in which the second outfeed support member 232 is arranged at least partially outside the cutout portion 220 and the upper portion 240 of the second outfeed support member 232 is not coplanar with the upper portion 216 of the first outfeed support member 208. The second outfeed support member 232 may pivot, slide, or otherwise move relative to the first outfeed support member 208 to move from the first position to the second position. In the illustrated embodiment, as is best seen in the rear views of the outfeed support assembly 200 depicted in FIGS. 4 and 5, the second outfeed support member 232 is pivotably connected to the first outfeed support member 208 by two hinges 248, one of which is arranged on each side region of the second outfeed support member 232 on the rear side (i.e. the side facing away from the table top 160) of the outfeed support assembly 200. The two hinges 248 are configured to enable the second outfeed support member 232 to pivot between the first position shown in FIGS. 3 and 4 and the second position, also referred to as a retracted position, shown in FIG. 5. In some embodiments, the two hinges 248 are configured to allow a limited range of motion, for example 180 degrees of motion, to disable the second outfeed support member 232 from pivoting past the position at which it is arranged in the plane of the adjacent portion of the first outfeed support member 208.

The outfeed support assembly 200 further includes a locking arrangement 260 configured to maintain the outfeed support assembly 200 in the upright position. In the illustrated embodiment, the locking arrangement 260 includes a pair of locking knobs 264 and two tabs 268 formed on the second outfeed support member 232. The locking knobs 264 are pivotably mounted to the first outfeed support member 208. When the second outfeed support member 232 is in the first position and the locking knobs 264 are in a locked position, the locking knobs 264 abut the rear surface of both the first and second outfeed support members 208, 232, thereby disabling pivoting of the second outfeed support member 232 relative to the first outfeed support member 208 out of the first position and toward the second position.

While the locking arrangement 260 of the illustrated embodiment includes two locking knobs 264, the reader should appreciate that another number, for example one, three, or more locking knobs 264 may be utilized in other embodiments. Additionally or alternatively, in some embodiments, some or all of the locking knobs 264 may be mounted to the second outfeed support member 232 and pivot so as to engage the first outfeed support member 208 in the locked position.

The tabs 268 extend below the axis 236 about which the second outfeed support member 232 pivots. Because the hinges 248 extend across the gap in the first outfeed support member 208 in which the tabs 268 are arranged in the upright position, the hinges 248 form a block preventing the two tabs 268 from rotating past the upright position. As a result, the interaction between the two tabs 268 and the two hinges 248 disable over rotation of the second outfeed support member 232 beyond the upright position. Thus, since the tabs 268 disable the second outfeed support member 232 from rotating past the upright position and, in the locked position, the locking knobs 264 disable the second outfeed support member 232 from pivoting from the upright position toward the retracted position, the combination of the locking knobs 264 and the tabs 268 enables the second outfeed support member 232 to be locked in the upright position.

In other embodiments, the locking arrangement 260 may include more or fewer than two of the locking knobs 264 and/or more or fewer than two of the tabs 268. In further embodiments, the locking arrangement 260 may include, for example, locking knobs that positively engage the second outfeed support member 232 to lock the second outfeed support member 232 in position, without including the tabs. In another embodiment, the locking arrangement 260 may include another suitable locking mechanism such as a clip, latch, or a pin.

The first outfeed support member 208 further includes a stop projection 272 assigned to each of the locking knobs 264. In the illustrated embodiment, the stop projections 272 are formed as portions of the first outfeed support member 208 that are cut and bent out of the plane of the first outfeed support member 208 to form stop surfaces 276. The locking knobs 264 are configured to rest against the associated stop surface 276 to retain the locking knobs 264 in the unlocked position. In other embodiments, the stop projections 272 may be formed as bumps or projections formed integrally with or attached to the rear surface of the first outfeed support member 208.

With reference now to FIGS. 4 and 5, a notch 284 is defined in the upper portion 240 of the second outfeed support member 232, forming a narrowed portion 288 of the second outfeed support member 232. A clip 292, configured as a spring clip in the illustrated embodiment, is formed on the rear surface of the first outfeed support member 208 at a lateral position that corresponds to the narrowed portion 288 of the second outfeed support member 232. When the second outfeed support member 232 is folded into the retracted position, the narrowed portion 288 is clipped into the clip 292 to retain the second outfeed support member 232 in the retracted position.

The two hinges 248 are mounted to the first outfeed support member 208 and second outfeed support member 232 by fasteners 296 that are generally flush with the front surface of the first outfeed support member 208 and second outfeed support member 232. Likewise, the locking knobs 264 are also mounted to the first outfeed support member 208 by fasteners 298 having a fastener head that is generally flush with the front surface of the first outfeed support member 208. In particular, the fasteners 298 may be screws that are countersunk or counterbored into the respective first outfeed support member 208 or second outfeed support member 232. Additionally, any other structures mounted to the first outfeed support member 208 and/or the second outfeed support member 232 may also be attached via fasteners that are flush with the respective first outfeed support member 208 or second outfeed support member 232. Since the fasteners 296, 298 are generally flush with the front surface of the first outfeed support member 208 and the second outfeed support member 232, the fasteners 296, 298 do not interfere with movement of the workpiece along the front surface of the first outfeed support member 208 and second outfeed support member 232 and, in particular, the fasteners 296, 298 are disabled from jamming or catching the workpiece.

As seen in FIG. 1, when in the upright position, the second outfeed support member 232 in combination with the first outfeed support member 208 provides outfeed support for a workpiece along the length of the outfeed support assembly 200, which is generally the same width as the table top 160. As a result, the outfeed support assembly 200 enables a wide degree of outfeed support for cutting large workpieces with the table saw 100.

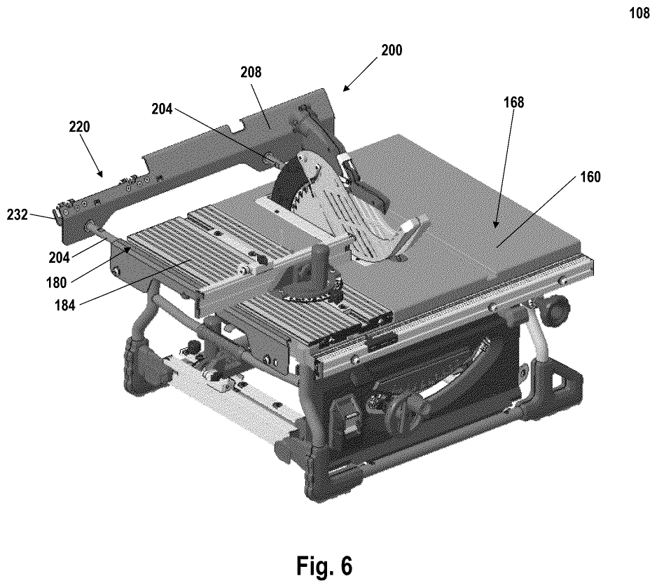

However, when the sliding table portion 180 is in use, the outfeed support assembly 200 would ordinarily block the plate 184 from extending beyond the first outfeed support member 208. To solve this problem, the user can unlock the locking arrangement 260 by twisting the locking knobs 264 out of engagement with the rear surface of the second outfeed support member 232, which unlocks the second outfeed support member 232. The user then pivots the second outfeed support member 232 downwardly until the narrowed portion 288 is clipped into the clip 292 in the retracted position, as shown in FIGS. 5 and 6. The plate 184 of the sliding table portion 180 can then slide beyond the left end portion of the first outfeed support member 208 through the cutout portion 220, while the remainder of the first outfeed support member 208 remains usable for workpiece support.

When the sliding table portion 180 is no longer in use, the outfeed support assembly 200 provides only limited support on the left side of the outfeed support assembly 200 since the second outfeed support member 232 is in the second, or retracted, position. Thus, when it is desired for the outfeed support assembly 200 to provide outfeed support along the entire width of the outfeed support assembly 200, the user removes the narrowed portion 288 of the second outfeed support member 232 from the clip 292 and pivots the second outfeed support member 232 from the second position to the first position shown in FIGS. 1-4. The user applies manual force to retain the second outfeed support member 232 in the position at which the tabs 268 engage the two hinges 248, holding the second outfeed support member 232 in the first position, while the user twists the locking knobs 264 to block the second outfeed support member 232 from pivoting out of the first position. The second outfeed support member 232 is then locked in the first position such that the upper portion 240 of the second outfeed support member 232 provides an extension of the support provided by the upper portion 216 of the first outfeed support member 208.

In conventional table saws with sliding tables and outfeed supports, the outfeed support assembly may include a cutout for the sliding table. However, when the sliding table is not in use, the region of the outfeed support at which the cutout is present lacks any support for the workpiece. In some conventional table saws, a small flag is arranged to the left of the cutout to provide additional support, but this small flag does not help when the workpiece has a width that ends within the region of the cutout. Further, the small flag must either extend beyond the left end of the table top, creating a potential safety hazard, or the width of the sliding table is limited such that it does not extend entirely to the left end of the table saw.

In contrast, the table saw 100 according to the disclosure enables the plate 184 of the sliding table portion 180 to extend to the left end of the table assembly 108, without limiting the outfeed support at the left end of the table assembly 108. Further, the table saw 100 enables outfeed support to be provided along the entire width of the outfeed support assembly 200, in particular in the portion of the first outfeed support member 208 in which the cutout portion 220 is defined.

It will be appreciated that variants of the above-described and other features and functions, or alternatives thereof, may be desirably combined into many other different systems, applications or methods. Various presently unforeseen or unanticipated alternatives, modifications, variations or improvements may be subsequently made by those skilled in the art that are also intended to be encompassed by the foregoing disclosure.

What is claimed is:

1. An outfeed support assembly for a table saw comprising:
a first outfeed support member having a first upper portion, the first outfeed support member defining a cutout portion; and
a second outfeed support member that is movably connected to the first outfeed support member, the second outfeed support member having a first position in which the second outfeed support member is arranged in the cutout portion and a second upper portion of the second outfeed support member is substantially coplanar with the first upper portion, and a second position in which the second outfeed support member is at least partially outside the cutout portion.

2. The outfeed support assembly of claim 1, wherein second outfeed support member pivots relative to the first outfeed support member between the first and second positions.

3. The outfeed support assembly of claim 2, further comprising at least one hinge connecting the first and second outfeed support members and enabling the second outfeed support member to pivot relative to the first outfeed support member.

4. The outfeed support assembly of claim 3, further comprising a locking arrangement having a locked position in which the second outfeed support member is locked in the first position, and an unlocked position in which the second outfeed support member is movable relative to the first outfeed support member.

5. The outfeed support assembly of claim 4, wherein the locking arrangement comprises at least one locking knob configured, in the locked position, to engage a surface of both the first and second outfeed support members so as to disable the second outfeed support member from pivoting from the first position toward the second position.

6. The outfeed support assembly of claim 5, wherein the locking arrangement further comprises at least one tab configured to limit a pivoting range of motion of the second outfeed support member relative to the first outfeed support member.

7. The outfeed support assembly of claim 6, wherein the locking arrangement further comprises a respective stop projection assigned to each locking knob of the at least one locking knob, each locking knob being configured to rest against the respective stop projection when the locking arrangement is in the unlocked position.

8. The outfeed support assembly of claim 5, wherein each hinge of the at least one hinge and each locking knob of the at least one locking knob is mounted to the respective first or second outfeed support member by one or more fasteners having a fastener head that is generally flush with a front surface of the respective first or second outfeed support member.

9. The outfeed support assembly of claim 2, further comprising a clip connected to the first outfeed support member and configured to receive the second outfeed support member in the second position.

10. The outfeed support assembly of claim 9, wherein the second outfeed support member defines a notch at a narrowed portion of the second outfeed support member, and the narrowed portion is received in the clip in the second position.

11. The outfeed support assembly of claim 10, wherein the clip is configured as a spring clip.

12. The outfeed support assembly of claim 1, wherein the first and second outfeed support members are configured as plates.

13. The outfeed support assembly of claim 1, wherein the outfeed support assembly is configured to mount to an underside of a table top of a table saw such that the first and second outfeed support members are translationally movable relative to the table top while the first and second upper portions are substantially coplanar with the table top.

14. A table saw comprising:
a table assembly having a table top and a sliding table portion; and
an outfeed support assembly comprising:
a first outfeed support member having a first upper portion, the first outfeed support member defining a cutout portion; and
a second outfeed support member that is movably connected to the first outfeed support member, the second outfeed support member having a first position in which the second outfeed support member is arranged in the cutout portion and a second upper portion of the second outfeed support member is substantially coplanar with the first upper portion, and a second position in which the second outfeed support member is at least partially outside the cutout portion.

15. The table saw of claim 14, wherein the cutout portion is aligned with a sliding axis of the sliding table portion.

16. The table saw of claim 15, wherein the table top has a support surface that is substantially coplanar with the first and second upper portions.

17. The table saw of claim 16, wherein the outfeed support assembly is movable relative to the table top in a direction of the sliding axis.

18. The table saw of claim 15, wherein the sliding table portion extends to an edge of the table top.

19. The table saw of claim 14, wherein the outfeed support assembly is mounted to an underside of the table top.

20. An outfeed support assembly for a table saw comprising:
a first outfeed support plate having a first upper portion, the first outfeed support plate defining a cutout portion; and
a second outfeed support plate that is movably connected to the first outfeed support plate, the second outfeed support plate having a first position in which the second outfeed support plate is arranged in the cutout portion and a second upper portion of the second outfeed support plate is substantially coplanar with the first upper portion, and a second position in which the second outfeed support plate is at least partially outside the cutout portion,
wherein second outfeed support plate pivots relative to the first outfeed support plate between the first and second positions about a pivot axis that is substantially parallel to a plane defined by the first and second upper portions.
